(19) United States
(12) Patent Application Publication
(10) Pub. No.: US 2007/0267853 A1
(43) Pub. Date: Nov. 22, 2007

(54) Side airbag apparatus

(75) Inventors: Hiroshi Kato, Aichi-ken (JP); Yuji Sato, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/797,094

(22) Filed: Apr. 30, 2007

(30) Foreign Application Priority Data
May 18, 2006 (JP) 2006-139205

(51) Int. Cl. B60R 21/233; B60R 21/207

(52) U.S. Cl. 280/730.2; 280/729; 280/740

(57) ABSTRACT

A side airbag apparatus includes an airbag. The airbag accommodates an inner tube (gas guiding member), which includes gas outlets. The inner tube accommodates an inflator (gas generator), which generates gas based on impact applied from the side of the vehicle. In the side airbag apparatus, the folded airbag is inflated and deployed between a vehicle seat and a body side portion as gas generated by the inflator is discharged from the gas outlets of the inner tube. Furthermore, when the airbag is in a folded state, the inner tube is folded with at least one of the gas outlets closed.

### BACKGROUND OF THE INVENTION

The present invention relates to a side airbag apparatus that reduces impact applied from the side of a vehicle.

For example, Japanese Laid-Open Patent Publication No. 5-42855 discloses a side airbag apparatus that protects an occupant from impact when the impact is applied from the side of a vehicle, such as in the case of side impact. An airbag module of the side airbag apparatus is provided in, for example, a side portion of a backrest of a vehicle seat. The airbag module includes an inflator, which generates gas, and an airbag, which is inflated and deployed by the gas discharged from the inflator.

In the side airbag apparatus, when an impact is applied to a body side portion of the vehicle from the side, gas is injected into the airbag from the inflator. The airbag is then inflated and deployed forward from the backrest in a narrow space between the occupant seated in the vehicle seat and the body side portion. Since the airbag that has been inflated and deployed in this manner is located between the occupant and the body side portion that bulges into the passenger compartment, the impact applied to the occupant from the side via the body side portion is reduced.

One type of side airbag apparatus includes an inner tube in the airbag. Gas outlets are provided at upper and lower ends of the inner tube. The inflator is arranged in the inner tube. In this type of the side airbag apparatus, gas is injected into the inner tube from the inflator. Thereafter, gas is injected into the airbag from both gas outlets of the inner tube, and is guided to the upper and lower sections in the airbag. The gas guided into the airbag as described above promptly inflates and deploys the upper and lower sections of the airbag, and the inflated and deployed airbag protects shoulders and the lumbar region of the occupant.

When an object such as a piece of baggage, which is weak against impact, is placed on the vehicle seat, the object might become an obstacle when the airbag is inflated and deployed. In this case, the object on the vehicle seat, that is, the obstacle is desirably not pushed with great force by the inflated and deployed airbag. However, according to the conventional side airbag apparatus, since portions of the airbag corresponding to the gas outlets are rapidly inflated and deployed, the obstacle on the vehicle seat is pushed by the airbag with great force. Such a problem might occur also in a case where a side airbag apparatus is used that includes an inner bag instead of the cylindrical inner tube in the airbag.

### SUMMARY OF THE INVENTION

Accordingly, it is an objective of the present invention to provide a side airbag apparatus, which includes a gas guiding member, such as an inner tube and an inner bag, in an airbag, in which the airbag is inflated and deployed without pushing, with great force, an obstacle located in a direction in which the airbag is deployed.

In accordance with one aspect of the present invention, a side airbag apparatus, which inflates and deploys a folded airbag between a vehicle seat and a body side portion, is provided. The apparatus includes an airbag, a gas guiding member, and a gas generator. The gas guiding member is located in the airbag. The gas guiding member includes a plurality of gas outlets. The gas generator is located in the gas guiding member. The gas generator generates gas in response to impact applied from a side of a vehicle. Gas generated by the gas generator is discharged from the gas outlets of the gas guiding member. In the folded state of the airbag, the gas guiding member is folded with at least one of the gas outlets closed.

### BRIEF DESCRIPTION OF THE DRAWINGS

FIG. 1 is a schematic side view illustrating a vehicle seat on which a side airbag apparatus is mounted;

FIG. 2 is a schematic plan view for explaining the positional relationship between the vehicle seat and a body side portion;

FIG. 3 is a side view, with a part cut away, illustrating an airbag module of a side airbag apparatus according to a first embodiment;

FIG. 4 is a side view, with a part cut away, illustrating the inner tube;

FIG. 5 is a side view illustrating the airbag module;

FIG. 6 is a side view illustrating a state where the upper and lower ends of the airbag are folded from the state of FIG. 5;

FIG. 7 is a side view illustrating a state where the airbag and the inner tube are further folded from the state of FIG. 6;

FIG. 8 is a cross-sectional view taken along line 8-8 of FIG. 7;

FIG. 9 is a side view illustrating the folded state of the airbag module;

FIG. 10 is a side view, with a part cut away, illustrating an airbag module of a side airbag apparatus according to a second embodiment;

FIG. 11 is a side view illustrating the relationship between the inner tube and mountain fold lines and valley fold lines; and

FIG. 12 is a side view, with a part cut away, illustrating an airbag module of a side airbag apparatus according to a third embodiment.

### DETAILED DESCRIPTION OF THE PREFERRED EMBODIMENTS

### First Embodiment

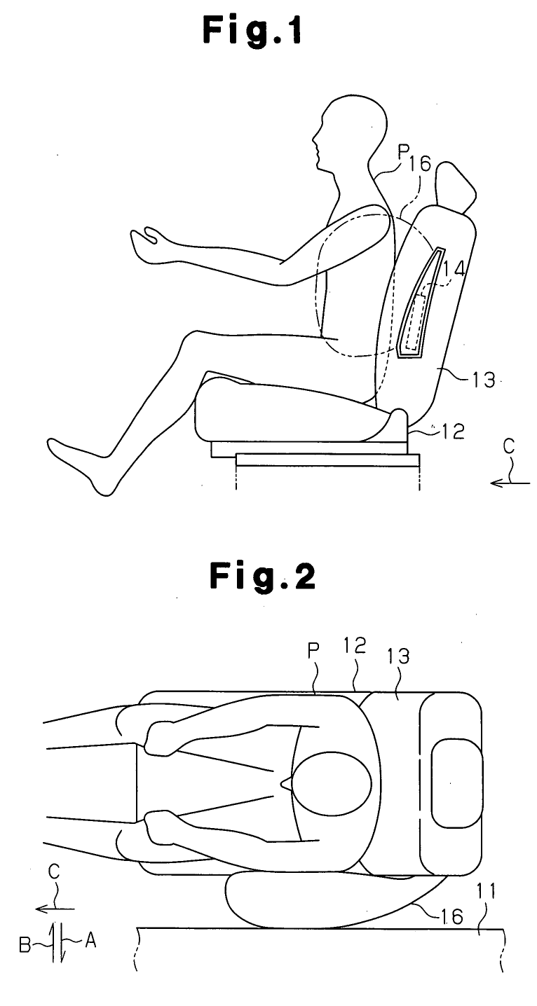

A first embodiment of the present invention will now be described with reference to FIGS. 1 to 9.

As shown in FIGS. 1 and 2, in a passenger compartment, a vehicle seat 12 is arranged inward of a body side portion 11, such as a door. An airbag module 14, which is a main part of a side airbag apparatus, is mounted on an outer portion of a backrest 13 of the vehicle seat 12, in a folded compact state.

In FIG. 2, arrow A is oriented toward the inside of the vehicle and arrow B is oriented toward the outside of the vehicle. Therefore, the directions shown by arrows A, B represent the width direction of the vehicle. Arrow C is oriented in the direction of travel of the vehicle, that is, the front direction. Arrows C in other drawings are also oriented in the front direction.

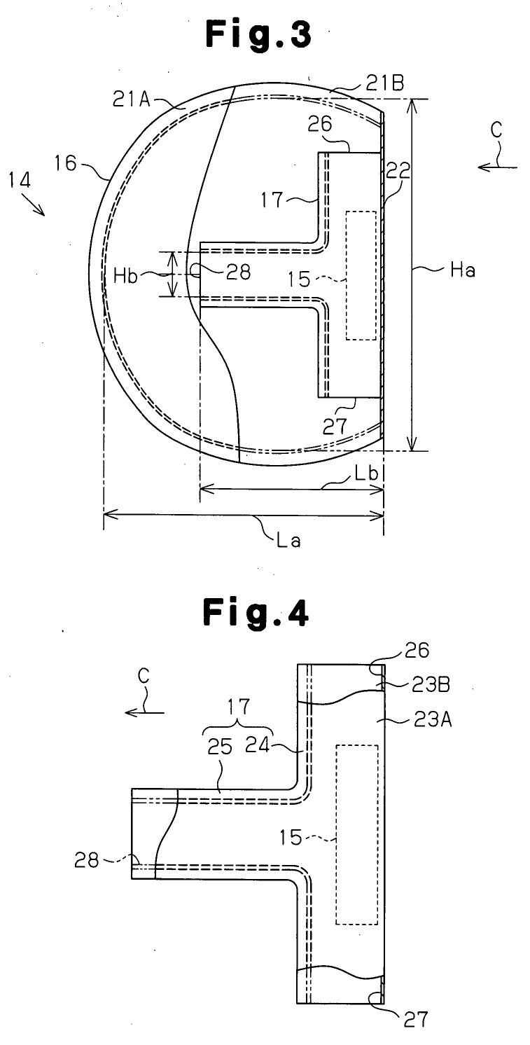

As shown in FIG. 3, the airbag module 14 includes a gas generator, which is an inflator 15 in this embodiment, an airbag 16, and a gas guiding member, which is an inner tube 17 in this embodiment. FIG. 3 shows the airbag module 14 before the airbag 16 is folded.

The inflator 15 is substantially columnar. The inflator 15 includes a gas outlet (not shown). The inflator 15 accommodates a gas generating agent (not shown). The gas generated by the gas generating agent is discharged outside of the inflator 15 from the gas outlet.

The airbag 16 is formed by sewing a base fabric such as a woven cloth. When sewing, a base fabric having a predetermined shape is folded at the center so that a pair of substantially circular overlapping pieces 21A, 21B are formed. The overlapping pieces 21A, 21B are sewn along the periphery except a folded part 22. The airbag 16 is attached to the inflator 15 to cover the inflator 15.

When an impact is applied to the body side portion 11 from a side, the airbag 16 is inflated and deployed between an occupant P seated in the vehicle seat 12 and the body side portion 11 as shown in FIG. 2 by gas discharged from the inflator 15. The airbag 16 is mainly deployed forward. The airbag 16 is inflated and deployed such that an upper section of the airbag 16 is located beside a shoulder region of the occupant P, a lower section of the airbag 16 is located beside the lumbar region of the occupant P, and a middle section of the airbag 16 is located beside the thorax region of the occupant P. The airbag 16 protects a large area from the shoulder region to the lumbar region of the occupant P from the body side portion 11 that has bulged into the passenger compartment.

As shown in FIGS. 3 and 4, the inner tube 17 guides the gas discharged from the inflator 15 in two or more directions in the airbag 16. Like the airbag 16, the inner tube 17 is formed by sewing a base fabric such as a woven cloth. When sewing, a substantially cruciform base fabric is folded at the center to form a pair of overlapping pieces 23A, 23B. The overlapping pieces 23A, 23B include a main body 24, which extends in the vertical direction, and an extending portion 25, which extends forward from the middle portion of the main body 24. The overlapping pieces 23A, 23B are sewn along the front peripheral portion of the main body 24 except the middle portion and a pair of the peripheral portions of the extending portion 25. That is, the overlapping pieces 23A, 23B are not sewn at the upper and lower ends of the main body 24 and the front end of the extending portion 25. Since specific parts of the overlapping pieces 23A, 23B are sewn as described above, openings are formed at the upper end, the lower end, and the front end of the inner tube 17. The opening located at the upper end of the main body 24 is an upper gas outlet 26, the opening located at the lower end of the main body 24 is a lower gas outlet 27, and the opening located at the front end of the extending portion 25 is a front gas outlet 28. The front gas outlet 28 faces forward, which is the direction in which the airbag 16 is mainly deployed. The gas discharged from the inflator 15 is guided to the upper, lower, and front sections in the airbag 16 from the gas outlets 26 to 28.

The inner tube used in a general side airbag apparatus includes gas outlets at only the upper and lower ends of the main body. Therefore, gas discharged from the inflator is guided to the upper and lower sections in the airbag from the gas outlets. In contrast, the inner tube 17 of the first embodiment includes the extending portion 25 provided on the main body 24. Thus, gas discharged from the inflator 15 is guided to, not only the upper and lower sections in the airbag, but also the front section in the airbag 16 by the extending portion 25.

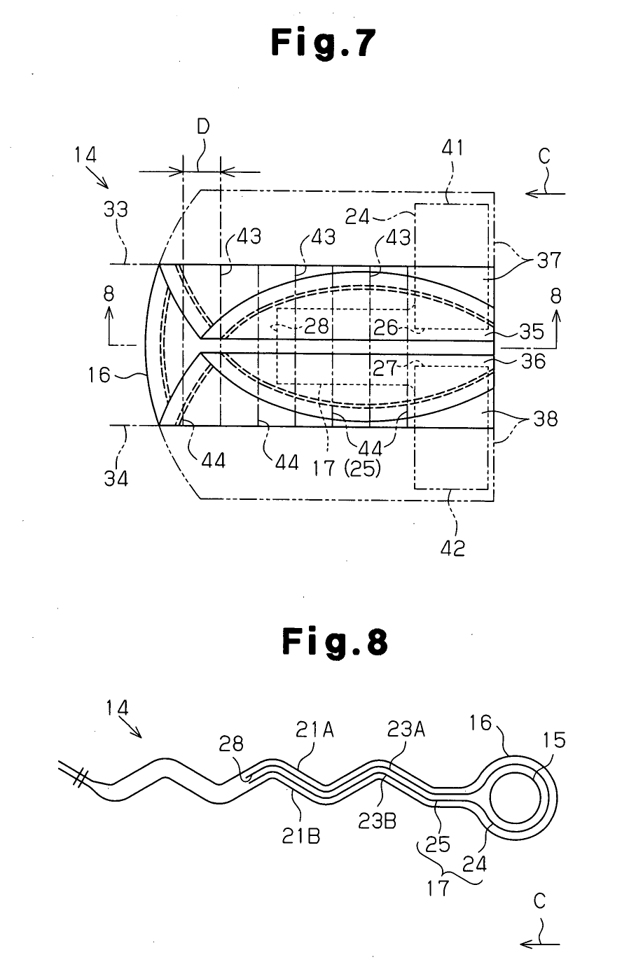

As shown in FIG. 3, assuming that the lateral length of the airbag 16 is represented by La, the lateral length of the inner tube 17 is represented by Lb, and the folding width when the airbag 16 is folded in the lateral direction is represented by D (see FIG. 7), the length Lb is desirably set to satisfy the relationship represented by the following expression (i).
0.5 D≦Lb≦1.5 La (i)

The lower limit (0.5 D) of the range represented by the expression (i) is the minimum length in which the extending portion 25 can be folded in the lateral direction. When the folding width D of the airbag 16 is 50 mm, the lower limit is 25 mm. According to the expression (i), the lateral length Lb of the inner tube 17 may be longer than the lateral length La of the airbag 16.

When assuming that the height of the airbag 16 is represented by Ha and the height (width) of the front gas outlet 28 of the extending portion 25 is represented by Hb, the height Hb is desirably set to satisfy the relationship represented by the following expression (ii).
10 mm≦Hb≦0.6 Ha (ii)

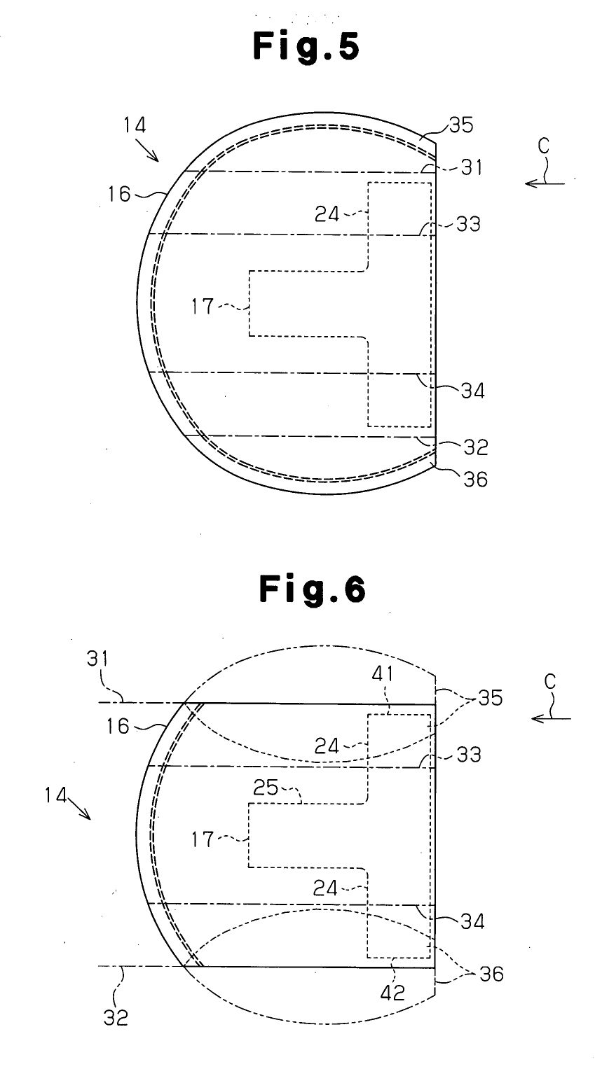

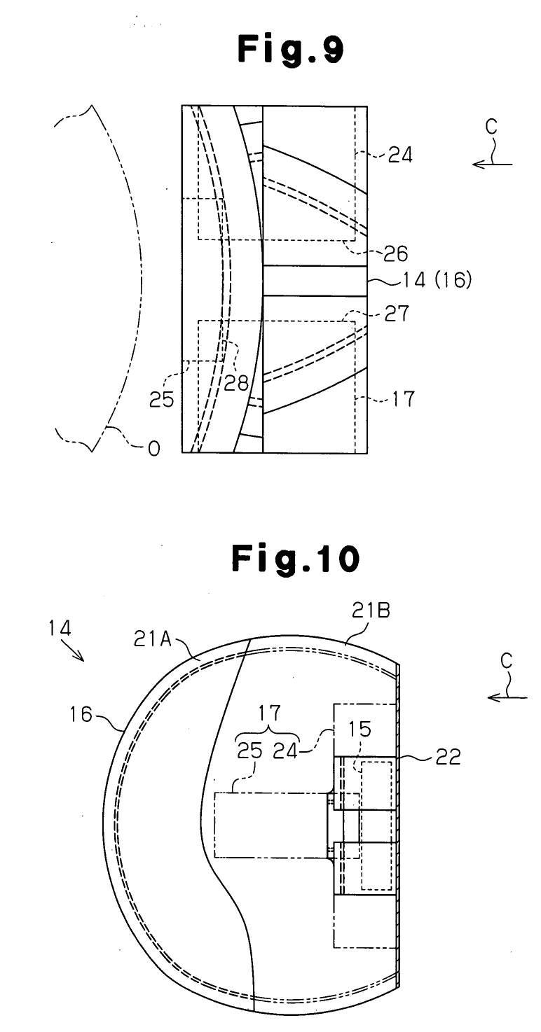

The airbag module 14 is mounted on the outer portion of the backrest 13 (see FIG. 1) with the airbag 16 and the inner tube 17 folded (hereinafter, referred to as a folded state) as shown in FIG. 9. The airbag module 14 is folded by, for example, processes shown in FIGS. 5 to 9.

First, the upper end portion and the lower end portion of the airbag 16 are folded in the order of FIGS. 5 to 7. As shown in FIG. 5, a pair of mountain fold lines 31, 32, which extend straight in the lateral direction, are set on the airbag 16. Furthermore, a pair of valley fold lines 33, 34, which extend straight in the lateral direction, are set between the mountain fold lines 31, 32. The main body 24 of the inner tube 17 lies over the valley fold lines 33, 34.

Next, as shown in FIG. 6, a section 35 of the airbag 16 upper than the mountain fold line 31 is mountain folded (away from the viewer) along the mountain fold line 31, and a section 36 of the airbag 16 lower than the mountain fold line 32 is mountain folded along the mountain fold line 32. That is, the sections 35, 36 are folded toward the back of the sheet of the drawing with the fold lines located outside. Furthermore, as shown in FIG. 7, a section 37 of the airbag 16 upper than the valley fold line 33 is valley folded (toward the viewer) along the valley fold line 33, and a section 38 of the airbag 16 lower than the valley fold line 34 is valley folded along the valley fold line 34. That is, the sections 37, 38 are folded toward the front of the sheet of the drawing with the fold lines located inside.

When folding the sections 37, 38, the main body 24 of the inner tube 17 is also valley folded. A section 41 of the main body 24 upper than the valley fold line 33 is valley folded together with the airbag 16 along the corresponding valley fold line 33, and a section 42 of the main body 24 lower than the valley fold line 34 is valley folded together with the airbag 16 along the corresponding valley fold line 34. Thus, the gas outlets 26, 27 of the main body 24 are closed. The airbag 16 folded in such a manner forms a substantially rectangular shape extending in the lateral direction (see the solid line in FIG. 7).

Subsequently, the airbag 16 is accordion-folded. At this time, mountain fold lines 43 and valley fold lines 44, which extend straight in the vertical direction, are set on the airbag 16. The intervals between the mountain fold lines 43 and the valley fold lines 44 are equal to the folding width D when the airbag 16 is accordion-folded. The extending portion 25 of the inner tube 17 is partially located over the mountain fold lines 43 and the valley fold lines 44.

The airbag 16 is accordion-folded along the mountain fold lines 43 and the valley fold lines 44 from the front end to the rear end of the airbag 16. At this time, the extending portion 25 of the inner tube 17 is also folded together with the airbag 16 along the mountain fold lines 43 and the valley fold lines 44. The front gas outlet 28 of the airbag 16 is closed by folding the inner tube 17. FIG. 8 shows a state where the airbag module 14 is in the process of being accordion-folded. When the airbag module 14 is accordion-folded, the airbag module 14 is brought into the folded state shown in FIG. 9.

The side airbag apparatus includes, besides the airbag module 14, an impact sensor and a controller, which are not shown. The impact sensor is configured by, for example, an acceleration sensor, and is provided in the body side portion 11 (see FIG. 2) of the vehicle. The impact sensor detects impact applied from the side of the body side portion 11. The controller controls operation of the inflator 15 based on a detection signal from the impact sensor.

According to the side airbag apparatus of the first embodiment, when impact greater than or equal to a predetermined value is applied to the body side portion 11, a detection signal is sent to the controller from the impact sensor. The controller sends a drive current to the inflator 15 based on the detection signal output from the impact sensor. The drive current heats the inflator 15 so that gas is generated from the gas generating agent in the inflator 15, and the gas is discharged from the gas outlet of the inflator 15. As the gas is injected in the airbag 16 via the inner tube 17, the airbag 16 starts to inflate and deploy.

When the airbag 16 is inflated and deployed, first, the pressure of the gas discharged from the inflator 15 acts on parts of the inner tube 17. Since the extending portion 25 is folded, the front gas outlet 28 of the inner tube 17 is closed. Furthermore, since the main body 24 is also folded, the upper and lower gas outlets 26, 27 of the inner tube 17 are closed. Thus, the inner tube 17 starts to inflate in the vicinity of the inflator 15. Subsequently, the extending portion 25 and the main body 24 are inflated and deployed causing the airbag module 14 to be unfolded.

At this time, when an obstacle such as a piece of baggage is not located in the direction in which the main body 24 of the inner tube 17 is deployed, that is, above or below the airbag module 14, and the direction in which the extending portion 25 is deployed, that is, in front of the airbag module 14, sufficient space exists for the airbag 16 to be inflated and deployed. In this case, there are not many factors that might hinder the airbag module 14 from being unfolded.

If there is no obstacle in the direction in which the main body 24 and the extending portion 25 are deployed, the extending portion 25 and the main body 24 are gradually unfolded by the gas pressure. This unfolds portions of the airbag 16 that are folded together with the inner tube 17 when folding the upper and lower end portions of the airbag 16 and accordion-folding the airbag 16. As the airbag 16 is unfolded, the inner tube 17 starts inflating and deploying, which causes the airbag 16 to start inflating and deploying in the same direction as the direction in which the inner tube 17 is deployed.

When the extending portion 25 of the inner tube 17 is unfolded, gas is injected to the front section in the airbag 16 from the front gas outlet 28. Also, when the main body 24 of the inner tube 17 is unfolded, gas is injected to the upper section and the lower section in the airbag 16 from the upper and lower gas outlets 26, 27.

As the gas is injected in this manner, the airbag 16 starts to promptly inflate and deploy forward, upward, and downward. The airbag 16 is promptly inflated and deployed at sections corresponding to the thorax region, the shoulder region, and the lumbar region of the occupant P.

When there is no obstacle in the direction in which the airbag 16 is deployed by the inner tube 17, the inner tube 17 is unfolded smoothly. Thus, the airbag 16 is instantly inflated and deployed toward a narrow space between the occupant P seated in the vehicle seat 12 and the body side portion 11 from the inside of the backrest 13. As a result, the inflated and deployed airbag 16 reduces the impact applied to the occupant P from the body side portion 11 that has bulged into the passenger compartment.

At the time when the pressure of the gas discharged from the inflator 15 acts on parts of the inner tube 17, a sufficient space might not exist for the extending portion 25 to be inflated and deployed due to an obstacle O located in the direction in which the extending portion 25 of the inner tube 17 is deployed, as shown by a chain double-dashed line in FIG. 9.

If the extending portion 25 is short and is not folded, and thus the front gas outlet 28 is not closed, the gas discharged from the inflator 15 flows through the extending portion 25 of the inner tube 17 and injected in the airbag 16 from the front gas outlet 28. This unfolds the airbag 16, which is then inflated and deployed forward. Thus, the obstacle O might be undesirably pushed with great force.

In this respect, in the first embodiment in which the extending portion 25 is folded with the airbag 16, the obstacle O hinders the airbag 16 and the extending portion 25 of the inner tube 17 from being unfolded. That is, the extending portion 25 is kept folded, which keeps the front gas outlet 28 closed. Therefore, gas is hindered from being discharged from the front gas outlet 28, which hinders the inner tube 17, that is, the airbag 16 from being unfolded. Thus, the obstacle O is not pushed by the airbag 16 from the rear with great force.

In a case where the inner tube 17 includes only the front gas outlet 28 as the gas outlet, when the front gas outlet 28 is closed, gas is kept supplied to the inner tube 17 excessively increasing the pressure in the inner tube 17. However, in the inner tube 17 of the first embodiment, the upper gas outlet 26 and the lower gas outlet 27 are provided in addition to the front gas outlet 28. Furthermore, in this state, the obstacle O does not exist above or below the airbag module 14.

Thus, in the same manner as when there is no obstacle O above, below, and in front of the airbag module 14, the pressure of gas starts to unfold the main body 24 in the vertical direction. Accordingly, the main body 24 starts to inflate and deploy. Then, the airbag 16 starts to inflate and deploy in the same direction as the direction in which the main body 24 is inflated and deployed. When the main body 24 is unfolded, gas is injected to the upper section and lower section in the airbag 16 from the gas outlets 26, 27 of the inner tube 17.

Also, since there is no obstacle O above or below the airbag module 14, the force that prevents the main body 24 from being unfolded is smaller than the force that prevents the extending portion 25 from being unfolded. Therefore, gas that is not discharged from the front gas outlet 28 flows through the main body 24 and injected to the upper section and the lower section in the airbag 16 from the gas outlets 26, 27. This is because the resistance in the main body 24 is smaller than that in the extending portion 25, and gas easily flows through the main body 24. Furthermore, as compared to a case where there is no obstacle above, below, and in front of the airbag module 14, the amount of gas discharged from the gas outlets 26, 27 is increased. This causes the airbag 16 to rapidly inflate and deploy upward and downward.

When the extending portion 25 is unfolded after the main body 24 is unfolded, the front gas outlet 28 that has been closed is opened. Then, gas is discharged from the opened front gas outlet 28 to the front section in the airbag 16.

When the obstacle O exists above or below the airbag module 14 into which the main body 24 is deployed, the side airbag apparatus operates in the same manner as when the obstacle O exists in front of the airbag module 14.

The first embodiment has the following advantages.

(1) The inner tube 17 includes the gas outlets 26 to 28. When the airbag 16 is in the folded state, the inner tube 17 is folded while closing the gas outlets 26 to 28. Thus, when there is no obstacle O in the direction in which the airbag 16 is deployed, the inner tube 17 is unfolded so that the airbag 16 is promptly and smoothly inflated and deployed.

When the obstacle O exists in only a certain direction in which the inner tube 17 is deployed, the corresponding section of the airbag 16 is hindered from being unfolded so that gas is suppressed from being discharged from the gas outlet toward the obstacle O. This prevents the obstacle O from being pushed by the airbag 16 with great force. Furthermore, gas is discharged from the gas outlets that face the direction in which the obstacle O does not exist. Thus, even if the obstacle O exists in the direction in which the airbag 16 is deployed, the airbag 16 is inflated and deployed without pushing the obstacle O with great force.

In the case of the side airbag apparatus in which the airbag 16 is inflated and deployed between the vehicle seat 12 and the body side portion 11, since the airbag module 14 is mounted on the outer portion of the backrest 13, the space between the backrest 13 and the body side portion 11 is particularly narrow. In contrast, the space in front of the backrest 13 is wider than the space beside the backrest 13. Therefore, the possibility that the obstacle O exists in the wide space is higher than the possibility that the obstacle O exists in the narrow space. Thus, the possibility that the obstacle O exists in front of the airbag 16 is higher than the possibility that the obstacle O exists above or below the airbag 16.

In this respect, the first embodiment includes the front gas outlet 28, which faces the direction (forward) in which the airbag 16 is mainly deployed, as the gas outlet that is closed by folding the inner tube 17. Therefore, gas can be prevented from being discharged in the direction in which there is a high possibility that the obstacle O exists. Thus, the airbag 16 is inflated and deployed without pushing the obstacle O with great force.

(2) The inner tube 17 has a shape in which the extending portion 25 is added to the main body 24. Thus, when there is no obstacle O in front of the folded airbag module 14, gas is discharged forward from the front gas outlet 28 so as to promote the forward inflation and deployment of the airbag 16. As a result, as compared to a case where the inner tube 17 includes only the main body 24, the airbag 16 is quickly inflated and deployed forward.

(3) In the side airbag apparatus, gas discharged from the front gas outlet 28 inflates the airbag 16 in the width direction of the vehicle. The time at which the airbag 16 starts to inflate depends on the time at which the gas is discharged from the front gas outlet 28.

In the first embodiment, when the airbag 16 is folded, the extending portion 25 is folded with the front gas outlet 28 being closed. Thus, as the folded section of the extending portion 25 is increased, that is, as the length of the extending portion 25 is increased, the time at which the extending portion 25 is unfolded is delayed. This delays the time at which gas is discharged from the front gas outlet 28. Therefore, by appropriately adjusting the length of the extending portion 25, the time at which gas is discharged, that is, the time at which the airbag 16 starts to inflate in the width direction of the vehicle is appropriately adjusted.

In particular, in the case of the side airbag apparatus in which the airbag 16 is inflated and deployed in a narrow space between the occupant P seated in the vehicle seat 12 and the body side portion 11, the airbag 16 is desirably instantly deployed forward from the backrest 13 without being inflated much in the width direction of the vehicle. The airbag 16 is desirably inflated in the width direction thereafter. To meet this demand, increasing the length of the extending portion 25 is effective. The same advantage is obtained in the case where the length Lb of the inner tube 17 is greater than the length La of the airbag 16 based on the condition that the expression (i) is satisfied.

(4) The inner tube 17 is folded simultaneously with the airbag 16. Thus, as compared to a case where the inner tube 17 and the airbag 16 are folded separately, the folding process is simplified.

### Second Embodiment

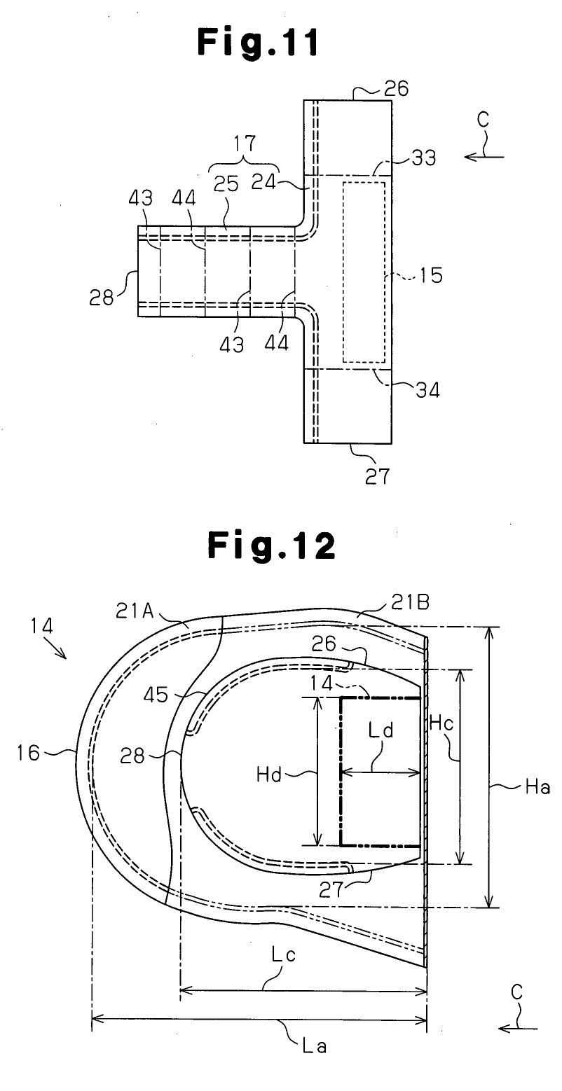

A second embodiment of the present invention will now be described with reference to FIGS. 10 and 11. Like or the same reference numerals are given to those components that are like or the same as the corresponding components of the first embodiment and detailed explanations are omitted.

The second embodiment differs from the first embodiment, in which the inner tube 17 is folded simultaneously with the airbag 16. Specifically, according to the second embodiment, the inner tube 17 is folded separately from the airbag 16. In this case, prior to folding the airbag 16, the inner tube 17 is folded. As shown in FIG. 11, the extending portion 25 is accordion-folded from the front end to the rear end along the mountain fold lines 43 and the valley fold lines 44, which extend in the vertical direction. Furthermore, the upper section and the lower section of the main body 24 are valley folded along the pair of valley fold lines 33, 34, which extend in the lateral direction.

The inner tube 17 that is folded and made compact as described above is arranged in the airbag 16 that is not folded yet as shown in FIG. 10. In this state, the airbag 16 is folded in the same manner as in the first embodiment. As a result, the airbag 16 is made compact with the inner tube 17 located inside the airbag 16 (see FIG. 9).

The second embodiment has the following advantage.

(5) Depending on the position of the obstacle O, the inner tube 17 might be hindered from being unfolded. Under such circumstance, if the inner tube 17 is folded together with the airbag 16 and a certain gas outlet (for example, the front gas outlet 28) is closed, it is difficult to unfold the airbag 16 at the portion that is folded with the inner tube 17. In this case, it is possible to discharge from other gas outlets (for example, the upper and lower gas outlets 26, 27) of the inner tube 17.

In this respect, according to the second embodiment, the inner tube 17 is folded separately from the airbag 16. Therefore, even if gas is hindered from being discharged from a certain gas outlet, gas discharged from other gas outlets reaches the vicinity of the closed gas outlet. Accordingly, the airbag 16 is unfolded, and is then inflated and deployed forward. That is, the airbag 16 can be unfolded regardless of the unfolding state of the inner tube 17.

### Third Embodiment

A third embodiment of the present invention will now be described with reference to FIG. 12. The third embodiment differs from the first and second embodiments, which include the inner tube 17 in the airbag 16. Specifically, according to the third embodiment, the airbag 16 accommodates a gas guiding member, which is an inner bag 45 in the third embodiment.

Like the inner tube 17, the inner bag 45 guides gas discharged from the inflator 15 to certain directions in the airbag 16. The inner bag 45 is formed by sewing a base fabric such as a woven cloth. When sewing, a base fabric having a predetermined shape is folded at the center to form a pair of overlapping pieces. The overlapping pieces are sewn along parts of the peripheral portion. That is, the upper end portion, the lower end portion, and the front end portion of the overlapping pieces are not sewn and are open. The openings of the upper end portion, the lower end portion, and the front end portion of the overlapping pieces are an upper gas outlet 26, a lower gas outlet 27, and a front gas outlet 28, respectively. The gas discharged from the inflator 15 is guided to the upper, lower, and front sections in the airbag 16 from the gas outlets 26 to 28.

As shown in FIG. 12, assuming that the lateral length of the airbag 16 is represented by La, the lateral length of the inner bag 45 is represented by Lc, and the lateral length of the airbag module 14 in the folded state is represented by Ld, the length Lc is preferably set to satisfy the following expression (iii).
(Ld+20 mm)≦Lc≦0.8 La (iii)

Furthermore, assuming that the height of the airbag 16 is represented by Ha, the height of the inner bag 45 is represented by Hc, and the height of the airbag module 14 in the folded state is represented by Hd, the height Hc is preferably set to satisfy the following expression (iv).
(Hd+40 mm)≦Hc≦0.8 Ha (iv)

The airbag module 14 is folded by the same processes as the first embodiment. In the case of the airbag module 14 of the third embodiment, when the airbag 16 is folded, the inner bag 45 is folded while closing at least one of the gas outlets 26 to 28. The third embodiment has the same advantages as the first embodiment.

The present invention may be embodied in the following modifications.

In the first and second embodiments, the extending portion 25 may be provided at portions of the main body 24 other than the middle portion. For example, a side airbag apparatus has been proposed in which the space in the airbag 16 is divided into chambers, and the adjacent chambers are connected to each other. In such a side airbag apparatus, a specific chamber can be inflated and deployed faster than other chambers by supplying a large amount of gas to that chamber. Therefore, for example, a specific region of the occupant P such as the lumbar region can be protected in preference. In such a side airbag apparatus, the extending portion 25 may be located in the specific chamber.

In the first and second embodiments, the extending portion 25 may be inclined with respect to the horizontal plane. In this case, gas generated by the inflator 15 is discharged from the front gas outlet 28 obliquely upward or obliquely downward.

In the first and second embodiments, the inner tube 17 may include two gas outlets or four or more gas outlets. For example, the inner tube 17 may be formed of only the main body 24 without the extending portion 25. Alternatively, the inner tube 17 may include a number of extending portions 25.

In the third embodiment, the inner bag 45 may include two gas outlets or four or more gas outlets. In this case, parts of the peripheral portion of the overlapping pieces to be sewn are changed while maintaining the shape of the overlapping pieces.

One of gas outlets does not need to be closed by folding the inner tube 17 or the inner bag 45. The inner tube 17 or the inner bag 45 may be folded while closing at least one of the gas outlets. In this case, for the same reason as the above mentioned advantage (1), the gas outlet to be closed when folding the inner tube 17 or the inner bag 45 preferably includes at least the gas outlet that faces the main deployment direction of the airbag 16.

The airbag 16, the inner tube 17, and the inner bag 45 may be folded by a method different from the above embodiments. The method for folding the airbag 16 may include, for example, roll-folding and tucking-in.

1. A side airbag apparatus, which inflates and deploys a folded airbag between a vehicle seat and a body side portion, the apparatus comprising:
an airbag;
a gas guiding member located in the airbag, the gas guiding member including a plurality of gas outlets; and
a gas generator located in the gas guiding member, the gas generator generating gas in response to impact applied from a side of a vehicle,
wherein gas generated by the gas generator is discharged from the gas outlets of the gas guiding member, and
wherein, in the folded state of the airbag, the gas guiding member is folded with at least one of the gas outlets closed.

2. The side airbag apparatus according to claim 1,
wherein the gas guiding member includes an upper gas outlet, which discharges gas generated by the gas generator upward, a lower gas outlet, which discharges the gas downward, a front gas outlet, which discharges the gas forward.

3. The side airbag apparatus according to claim 1,
wherein the gas guiding member is folded separately from the airbag.

4. The side airbag apparatus according to claim 1,
wherein the gas guiding member is folded together with the airbag.

5. The side airbag apparatus according to claim 1,
wherein the gas guiding member is an inner tube, which includes the gas outlets at ends of the inner tube.

6. The side airbag apparatus according to claim 1,
wherein the gas guiding member is an inner bag, which includes the gas outlets at a peripheral portion of the inner bag.

7. The side airbag apparatus according to claim 1,
wherein at least one of the gas outlets that faces the main deployment direction of the airbag is closed by folding the gas guiding member.

8. The side airbag apparatus according to claim 2,
wherein the gas guiding member includes a main body, which extends in a vertical direction, and an extending portion, which extends forward from a middle portion of the main body.

9. The side airbag apparatus according to claim 8,
wherein the gas guiding member includes the upper gas outlet at an upper end of the main body, the lower gas outlet at a lower end of the main body, and the front gas outlet at a front end of the extending portion.

10. The side airbag apparatus according to claim 9,
wherein the front gas outlet is closed by folding the gas guiding member.

11. The side airbag apparatus according to claim 10,
wherein the upper gas outlet and the lower gas outlet are closed by folding the gas guiding member.
